(19) United States
(12) Patent Application Publication
(10) Pub. No.: US 2009/0094413 A1
(43) Pub. Date: Apr. 9, 2009

(54) Techniques for Dynamic Volume Allocation in a Storage System

(76) Inventors: Douglas L. Lehr, Tucson, AZ (US); Franklin E. McCune, Tucson, AZ (US); David C. Reed, Tucson, AZ (US); Max D. Smith, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/868,849

(22) Filed: Oct. 8, 2007

(51) Int. Cl. G06F 12/00

(52) U.S. Cl. 711/112; 711/E12.001

(57) ABSTRACT

A technique for operating a storage system includes determining utilization of multiple storage volumes over a time period. One or more application datasets are then reassigned to a different one of the multiple storage volumes based on the utilization of the multiple storage volumes over the time period and a requested performance level for an associated application.

### BACKGROUND

1. Field

This disclosure relates generally to a storage system and, more specifically to techniques for dynamic volume allocation in a storage system.

2. Related Art

In a typical storage system, a hierarchy of structures is used to manage hard disk drive (HDD) storage. Typically, each individual HDD, generally known as a physical volume (PV), has been assigned a name. In at least one storage system, each PV in use belongs to a volume group (VG) and all of the PVs in a volume group are divided into physical partitions (PPs) of the same size. In this storage system, each PV is divided into five regions (i.e., an outer_edge, an inner_edge, an outer_middle, an inner_middle, and a center) for space-allocation purposes. The number of physical partitions in each region has generally varied, depending on a total capacity of the HDD. Within each VG, one or more logical volumes (LVs) have usually been defined. In general, LVs are groups of information located on PVs. Data on LVs appears to be contiguous to the user, but can be discontiguous on a PV. This allows file systems, paging space, and other LVs to be resized or relocated, to span multiple PVs, and to have their content replicated for greater flexibility and availability in the storage of data.

Each LV includes one or more logical partitions (LPs). Each LP corresponds to at least one physical partition (PP). If mirroring is specified for the LV, additional PPs are usually allocated to store the additional copies of each LP. Although the LPs are numbered consecutively, the underlying PPs are not necessarily consecutive or contiguous. LVs can usually serve a number of purposes, such as paging, but each LV usually serves a single purpose. An LV may contain a single journaled file system (JFS or JFS2), with each JFS including a pool of page-size (e.g., 4 KB) blocks. When data is to be written to a file, one or more additional blocks are allocated to that file. These blocks might not be contiguous with one another or with other blocks previously allocated to the file. A given file system can be defined as having a fragment size of less than 4 KB (e.g., 512 bytes, 1 KB, 2 KB).

After installation, a typical storage system has one VG (the root VG), which includes a base set of LVs that are required to start the system and any other LVs specified via an installation script. PVs connected to the storage system can be added to a VG (using, for example, an extendvg command). In general, a PV can be added either to the rootvg VG or to another VG (defined using, for example, the mkvg command). LVs can be tailored using, for example, commands, a menu-driven system management interface tool (SMIT) interface, or a web-based system manager.

Today, administrators of storage systems are challenged to improve performance and utilization of available direct access storage devices (DASDs), e.g., HDDs arranged in a redundant array of inexpensive disks (RAID) configuration. While administrators of storage systems have been able to initially choose LVs where groups of DASD datasets are stored, the assignment of DASD datasets has been static. In this case, when multiple applications that execute at the same time access different DASD datasets on a common PV, optimal operation of the multiple applications may not be realized.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example storage system that employs dynamic volume allocation, according to various embodiments of the present disclosure.

FIG. 2 is a flowchart of an example process for performing dynamic volume allocation in a storage system, according to various embodiments of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. The computer-usable or computer-readable storage medium can even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. As used herein, the term “coupled” includes both a direct electrical connection between blocks or components and an indirect electrical connection between blocks or components achieved using intervening blocks or components.

According to various aspects of the present disclosure a correct volume (e.g., physical or logical volume) for a dataset is periodically assessed to determine if moving the dataset to a different volume is desirable. For example, a dataset may be moved if an average response time of an associated hard disk drive (HDD) changes, when a customer changes requirements for the dataset, or when a new HDD comes on-line. As a given dataset may be located on multiple physical and logical volumes, by examining attributes and performance characteristics at a dataset level, datasets may be advantageously reassigned to different physical or logical volumes in an attempt to ensure each dataset is provided a performance level desired by a customer. In general, the techniques disclosed herein may be employed to provide desired response times for input/output (I/O) commands by adjusting physical or logical volumes of specific datasets, as needed, to maintain customer defined characteristics. The locations of datasets on physical or logical volumes may be modified after they have been allocated if the datasets are not achieving desired characteristics, or if the desired characteristics for the dataset have changed. In essence, physically moving a dataset to a higher performing (physical or logical) volume, or vice versa if that dataset does not require the level of performance of the volume it has been allocated, increases the performance provided by an associated storage system.

According to various aspects of the present disclosure, datasets are usually ensured of receiving a required performance level, irrespective of the number of volumes the dataset spans, as the dataset can be moved to one or more higher performing physical or logical volumes (assuming higher performing volumes are available). In this manner, dataset performance requirements may be met following initial allocation. For example, performance requirements for a dataset may be periodically measured and if a required performance is not being met, the dataset can be moved to a better performing (physical or logical) volume or volumes. Moreover, when a measured performance exceeds a required performance, the dataset may be moved to a lesser performing (physical or logical) volume or volumes. In essence, dataset performance may be analyzed irrespective of the number of physical or logical volumes spanned by the dataset.

Statistics may be gathered based on input/output (I/O) to DASD activity. Groups of datasets or a single dataset may then be moved to a different (physical or logical) volume or volumes (on an as needed basis), based on the statistics and a user requested performance level for an application. The time for moving the datasets may also be based on input received from a user. Advantageously, the techniques disclosed herein generally facilitate improved application response times without the need for increased DASD. The statistics, which may be gathered by a system utility, may be analyzed by a tool that is run on a periodic basis, e.g., a daily basis. For example, the system utility may create system management facility (SMF) records that log various statistics, e.g., reads/writes to DASDs, associated software identifications, and time periods. The statistics can then be compared against user specified criteria, such as application priority, excluded datasets, and specified times when alterations in volume assignment can occur. According to various aspects of the present disclosure, when a decision is made to move a group of application datasets to a different (physical or logical) volume or volumes, the system utility facilitates the movement of the application datasets to the selected volume or volumes and compiles a report of the change.

According to one aspect of the present disclosure, a technique for operating a storage system includes determining utilization of multiple storage volumes over a time period. One or more application datasets are then reassigned to a different one of the multiple storage volumes based on the utilization of the multiple storage volumes over the time period and a requested performance level for an associated application.

According to another aspect of the present disclosure, a storage system is disclosed that includes a direct access storage device and a processor coupled to the direct access storage device. The processor is configured to determine utilization of multiple storage volumes of the direct access storage device over a time period. The processor is also configured to reassign one or more application datasets to a different one of the multiple storage volumes based on the utilization of the multiple storage volumes over the time period and a requested performance level for an associated application.

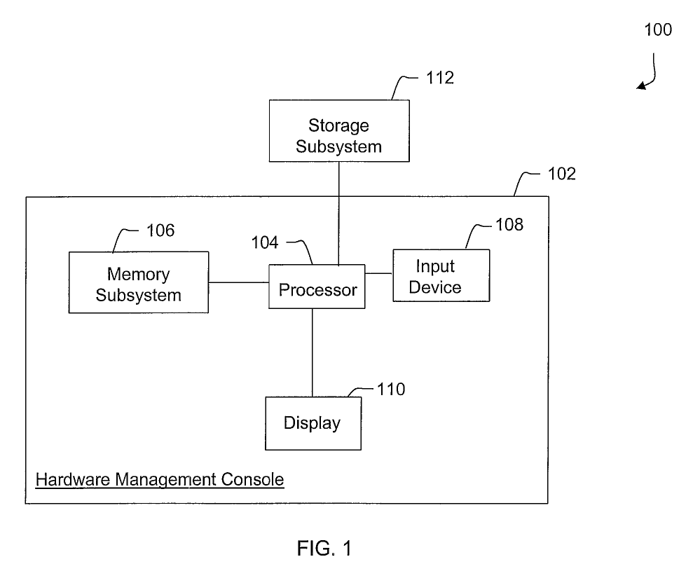

With reference to FIG. 1, an example storage system 100 (e.g., a DS8000 series storage system manufactured and made commercially available by IBM Corp.) is illustrated that may be configured to select a best volume or volumes for a dataset according to the present disclosure. As is shown, the system 100 includes a hardware management console (HMC) 102 that is coupled to a storage subsystem (product) 112. A volume selection application may be locally stored on the HMC (computer system) 102 or stored on a different computer system (e.g., a computer system that is included as part of the storage subsystem 112). The storage subsystem 112 may include, for example, multiple servers, and multiple direct access storage devices (DASDs), e.g., hard disk drives (HDDs) arranged in a redundant array of inexpensive disks (RAID) configuration.

As is illustrated, the HMC 102 includes a processor 104 (including one or more central processing units (CPUs)) that is coupled to the memory subsystem 106 (which includes an application appropriate amount of volatile and non-volatile memory), an input device 108 (e.g., a keyboard and a mouse), and a display 110 (e.g., a cathode ray tube (CRT) or a liquid crystal display (LCD)). The HMC 102 may be utilized, for example, by an administrator that is attempting to setup, maintain, or troubleshoot operation of the storage subsystem 112. The processor 104 of the HMC 102 is in communication with the storage subsystem 112 and may receive input from an administrator via, for example, a command line interface (CLI) provided via the display 110. Alternatively, the management console may be incorporated within the storage subsystem 112 or within another system or subsystem.

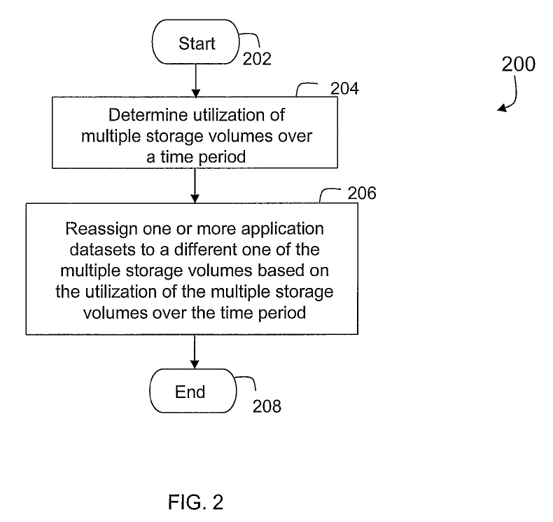

Moving to FIG. 2, an example process 200 for operating the storage system 100, is illustrated. In block 202, the process 200 is initiated at which point control transfers to block 204. In block 204, the processor 104 executes code for determining utilization of multiple storage volumes over a time period. The processor 104 may access various records to determine the utilization of a given volume. The storage volumes may correspond to physical volumes, logical volumes, or both physical and logical volumes. Next, in block 206, the processor 104 reassigns on or more application datasets to a different one of the multiple storage volumes based on the utilization of the multiple storage volumes over time, as compared to requirements for the application. For example, if the application requirements are being exceeded, the application dataset may be assigned to a lower performing volume or volumes. As another example, if the application requirements are not being met, the application dataset may be assigned to a higher performing volume or volumes (assuming the higher performing volume or volumes are available). Following block 206, control transfers to block 28 where the process 200 returns to a calling process.

Accordingly, techniques have been disclosed herein that generally improve application performance by reassigning application datasets to different storage volumes, in view of user provided performance criteria.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of operating a storage system, comprising:
determining utilization of multiple storage volumes over a time period; and
reassigning one or more application datasets to a different one of the multiple storage volumes based on the utilization of the multiple storage volumes over the time period and a requested performance level for an associated application.

2. The method of claim 1, wherein the determining utilization of multiple storage volumes further comprises:
gathering data related to an activity level of each of the multiple storage volumes over the time period; and
analyzing the data to determine the utilization of the multiple storage volumes over the time period.

3. The method of claim 1, wherein the multiple storage volumes include physical volumes.

4. The method of claim 1, wherein the multiple storage volumes include logical volumes.

5. A storage system, comprising:
a direct access storage device; and
a processor coupled to the direct access storage device, wherein the processor is configured to:
determine utilization of multiple storage volumes of the direct access storage device over a time period; and
reassign one or more application datasets to a different one of the multiple storage volumes based on the utilization of the multiple storage volumes over the time period and a requested performance level for an associated application.

6. The storage system of claim 5, wherein the processor is configured to determine utilization of the multiple storage volumes of the direct access storage device over the time period by:
gathering data related to an activity level of each of the multiple storage volumes over the time period; and
analyzing the data to determine the utilization of the multiple storage volumes over the time period.

7. The storage system of claim 5, wherein the multiple storage volumes include physical volumes.

8. The storage system of claim 5, wherein the multiple storage volumes include logical volumes.
